(19) United States
(12) Patent Application Publication
(10) Pub. No.: US 2014/0254728 A1
(43) Pub. Date: Sep. 11, 2014

(54) METHOD FOR GRAY CODING A SYMBOL ALPHABET

(71) Applicant: Astrapi Corporation, Dallas, TX (US)

(72) Inventors: Nigel JONES, Frederick, MD (US); Jerrold PROTHERO, Washington, DC (US)

(73) Assignee: Astrapi Corporation, Dallas, TX (US)

(21) Appl. No.: 14/199,722

(22) Filed: Mar. 6, 2014

Related U.S. Application Data
(60) Provisional application No. 61/774,270, filed on Mar. 7, 2013.

(51) Int. Cl. H04L 25/03

(52) U.S. Cl. CPC H04L 25/03305; H04L 25/03197
USPC 375/341

(57) ABSTRACT

A method for Gray coding a symbol alphabet transmitted utilizing a plurality of non-periodic waveforms. The method for Gray coding a symbol alphabet transmitted utilizing a plurality of non-periodic waveforms may include producing a matched filter for each of the non-periodic waveforms, forming an adjacency matrix indicating which symbols are most likely to be confused with each other, ordering the symbols accordingly, and applying a Gray code to the ordered symbols. The method may also include a symbol alphabet with a plurality of symbols that may also include means for building an adjacency matrix describing likelihood of inter-symbol interference and means for ordering the symbols based on the adjacency matrix and for Gray coding the ordered symbols. The method may also include applying a standard Gray code to an ordered symbol list such that successive symbols in the ordered list are assigned bit sequences that differ by one bit.

### CROSS-REFERENCE TO RELATED APPLICATIONS

This application claims priority to U.S. Provisional Patent Application No. 61/774,270 filed Mar. 7, 2013 and entitled GRAY CODES FOR NON-PERIODIC SIGNALS, the entire contents of which are hereby incorporated by reference.

### BACKGROUND

The utilization of Gray codes is well known in the art of digital telecommunications as a means to reduce bit errors in the symbols used in signal transmission over noisy channels. All transmissions in digital telecommunications are made using an alphabet of symbols for a particular transmission chosen from among the many such alphabets that exist in order to convey the information that is desired to be transmitted, each symbol conveying one piece of that information and each symbol being uniquely defined in that alphabet by its pattern of bits. For example, if a symbol is comprised of 8 bits, then there can be 256 unique symbols in an associated alphabet, and each symbol will have a unique pattern of its 8 bits. If during transmission one of those bits in a symbol is changed (from a “zero” to a “one” or from a “one” to a “zero”, then the originally transmitted symbol is changed into a different symbol of the alphabet and there is an error when the signal is received. For instance, in the technique of Quadrature Amplitude Modulation or QAM, a constellation diagram is arranged so that bit patterns conveyed by adjacent constellation points, each corresponding to a symbol in the communication alphabet, differ by only one bit. This means that the symbol confusions most likely to occur in the receiver will produce the minimum possible number of bit errors.

For signal modulation techniques in which each symbol in the communication alphabet corresponds uniquely to a single point in the constellation diagram, techniques for identifying a suitable Gray code are straight-forward and well-understood. This includes standard signal modulation techniques such as Quadrature Amplitude Modulation or QAM, Phase-Shift Keying or PSK and Pulse Amplitude Modulation or PAM.

A feature that QAM, PSK, PAM and other standard modulation techniques have in common is that they are all based on and use periodic sine and cosine carrier waves. It is known from the sampling theorem used in the derivation of the Shannon-Hartley law that band limited periodic waveforms may be fully reconstructed by sampling at two times the frequency of the communication channel's baseband bandwidth. Consequently, if symbols are transmitted at the rate of the baseband bandwidth, each symbol may be characterized (that is, identified) by at most two independent points; and, in practice, one complex point is utilized. This is the logic behind the use of constellation diagrams in which each symbol is represented by a single complex point, as is standard for traditional signal modulation techniques.

However, it has recently become known in the art that a new class of signal modulation techniques based on non-periodic waveforms is not limited to two independent points per symbol transmitted at the baseband bandwidth. This arises from the fact that the proof of the sampling theorem makes use of Fourier analysis in a way that implicitly assumes that the band limited signal is constructed from periodic functions. By removing the periodicity assumption, it is possible to prove that independent points may be transmitted at a rate much higher than twice the baseband bandwidth as had previously been assumed to be the limit. In fact, it is possible to prove that by building band limited signals from non-periodic functions, independent points can be transmitted at a rate arbitrarily higher than twice the baseband bandwidth, ultimately limited by the communication system's sampling rate and slew rate.

An implication of this is that whereas a standard periodic symbol corresponds naturally to a single point in the complex plane, a non-periodic symbol corresponds more naturally to a sequence of complex points (i.e., a trajectory). These points may be uniformly distributed in time, but need not be. The use of non-periodic signal modulation provides a great deal more flexibility and noise-resistance than was previously achievable. However, it also complicates the problem of identifying an appropriate Gray code. In transmissions using the standard periodic waveform regime in which each symbol can be characterized as a single complex point in the complex plane used to represent such transmissions, adjacent symbols (i.e., those most likely to be confused in the receiver) may be identified simply in terms of Euclidean distance in the complex plane. It is less clear how adjacency should be defined for complex trajectories. And given an adjacency measure, it is unknown how it may be converted into an appropriate Gray code.

### SUMMARY OF THE INVENTION

In one exemplary embodiment, a method for performing Gray coding of a symbol alphabet transmitted utilizing non-periodic waveforms is described. The method may include identifying a sequence of complex points corresponding to each of the non-periodic waveforms that may be used in a transmission, producing a matched filter for each of the non-periodic waveforms as is well-known to the art, building an adjacency matrix describing likelihood of inter-symbol interference by convolving each symbol waveform with the matched filter for each symbol waveform and recording the strength of each match in the adjacency matrix, and traversing the adjacency matrix to order the symbols and Gray code the ordered symbols.

In signal processing, a matched filter may be used to correlate a known signal or template against an unknown signal in order to detect the presence of the template in the unknown signal. In the present invention, a “template” is the ideal version of a symbol waveform uncorrupted by noise. This process of determining which symbols are in the transmission may be implemented by convolving the unknown signal with a normalized conjugated time-reversed version of each template symbol waveform (the “matched filter”) as is well known in the transmission art. The matched filter may be the optimal linear filter for maximizing the Signal-to-Noise Ratio or SNR in the presence of Additive White Gaussian Noise or AWGN.

Since the symbols used in a transmission utilizing non-periodic waveforms may be associated with trajectories in the complex plane for analysis purposes, for channels affected by AWGN it may be appropriate for the receiver to utilize a set of matched filters in order to distinguish between the symbols. In this case, the symbols most likely to be confused by the receiver correspond to those having symbol waveform matched filters with the most similar response. An adjacency measure for the non-periodic symbols may be constructed by examining the degree of similarity between the symbol waveform matched filters. Based on traversing this adjacency information, an individual Gray code may be assigned to each of the non-periodic symbols in order to minimize bit errors.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram showing a Gray code for converting a standard set of binary numbers into their corresponding Gray code representations.

FIG. 2 is an exemplary diagram showing a constellation diagram.

FIG. 3 is an exemplary diagram showing a plurality of modulation techniques.

FIG. 4 is an exemplary diagram showing an adjacency matrix.

FIG. 5 is an exemplary diagram showing a flow chart of a symbol alphabet transmitted utilizing a plurality of non-periodic waveforms.

FIG. 6 is an exemplary diagram showing a flow chart of a method for Gray coding a symbol alphabet transmitted utilizing a plurality of non-periodic waveforms.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the term “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein may be performed by specific circuits (i.e., Application Specific Integrated Circuits or ASICs) and/or by program instructions executed by at least one processor. Additionally, the sequence of actions described herein may be embodied entirely within any form of computer-readable storage medium such as non-transitory storage media such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described actions.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

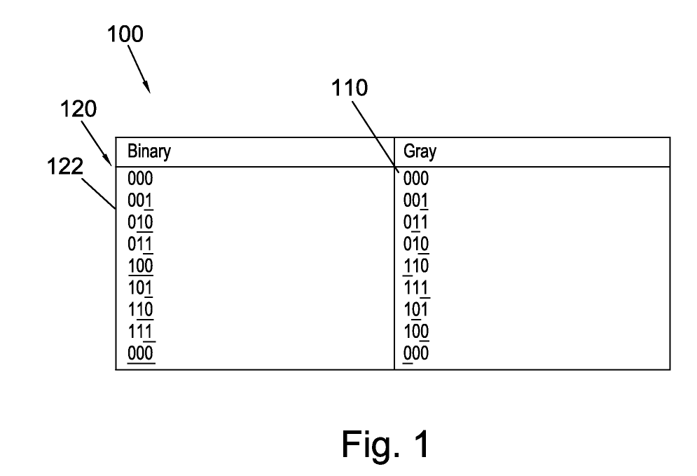

FIG. 1 is an exemplary diagram showing a plurality of Gray codes 100. The Gray codes 100 may include a first column 110. The Gray codes 100 are shown in FIG. 1 adjacent to a plurality of binary codes 120. The binary codes 120 may be in a second column 122.

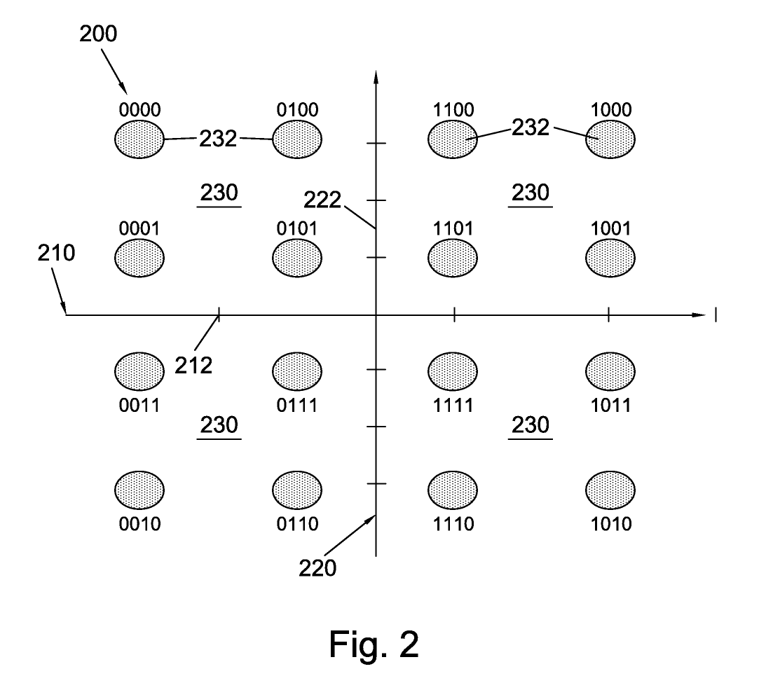

FIG. 2 is an exemplary diagram showing a constellation diagram 200. The constellation diagram 200 may include an X-axis 210, a Y-axis 220 and a plurality of quadrants 230. The constellation diagram 200 may be arranged to reduce errors. The X-axis 210 may include a plurality of first constellation values 212. The Y-axis 220 may include a plurality of second constellation values 222. The quadrants 230 may include a plurality of constellations 232 disposed within the quadrants 230.

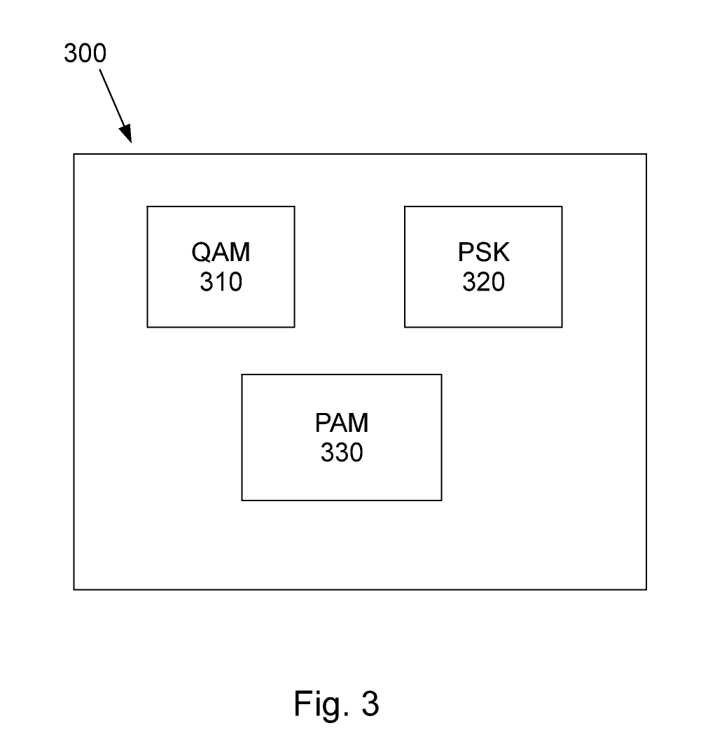

FIG. 3 is an exemplary diagram showing a plurality of standard modulation techniques used in transmissions using periodic waveforms 300. The modulation techniques 300 may include Quadrature Amplitude Modulation or QAM 310, Phase-Shift Keying or PSK 320 and Pulse Amplitude Modulation or PAM 330. QAM 310 is based on periodic sine and cosine carrier waves. PSK 320 is based on periodic sine and cosine carrier waves. PAM 330 is based on periodic sine and cosine carrier waves.

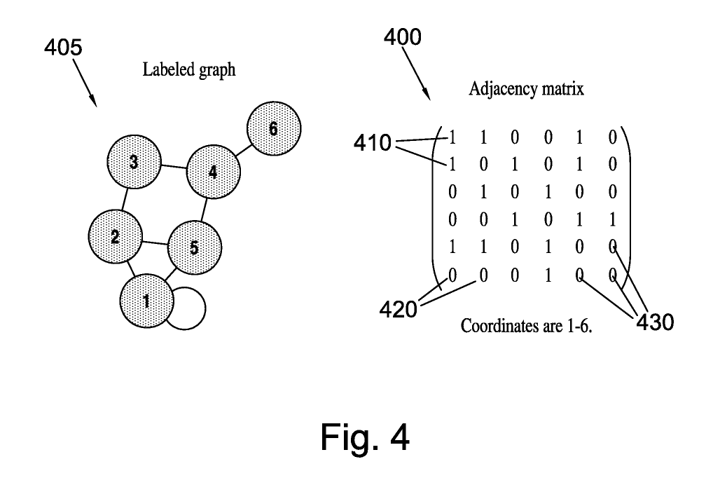

FIG. 4 is an exemplary diagram showing an adjacency matrix 400. The adjacency matrix 400 shown in FIG. 4 is for coordinates 1 to 6 of the labeled graph 405 and is adjacent to the labeled graph 405. The labeled graph 405 corresponds to the adjacency matrix 400. The adjacency matrix 400 may have a plurality of rows 410, a plurality of columns 420 and a plurality of binary numbers 430. The binary numbers 430 may be disposed within the rows 410 and the columns 420. The binary numbers 430 may form coordinates 1 to 6 which corresponds to coordinates 1 to 6 from the labeled graph 405. Note that while this exemplary diagram conveys the idea of an adjacency matrix in a simple form, it differs from the adjacency matrix of the present invention in an important way: FIG. 4 indicates binary adjacency (a node is either adjacent or it is not) whereas in the present invention adjacency is a continuous distance measure between nodes.

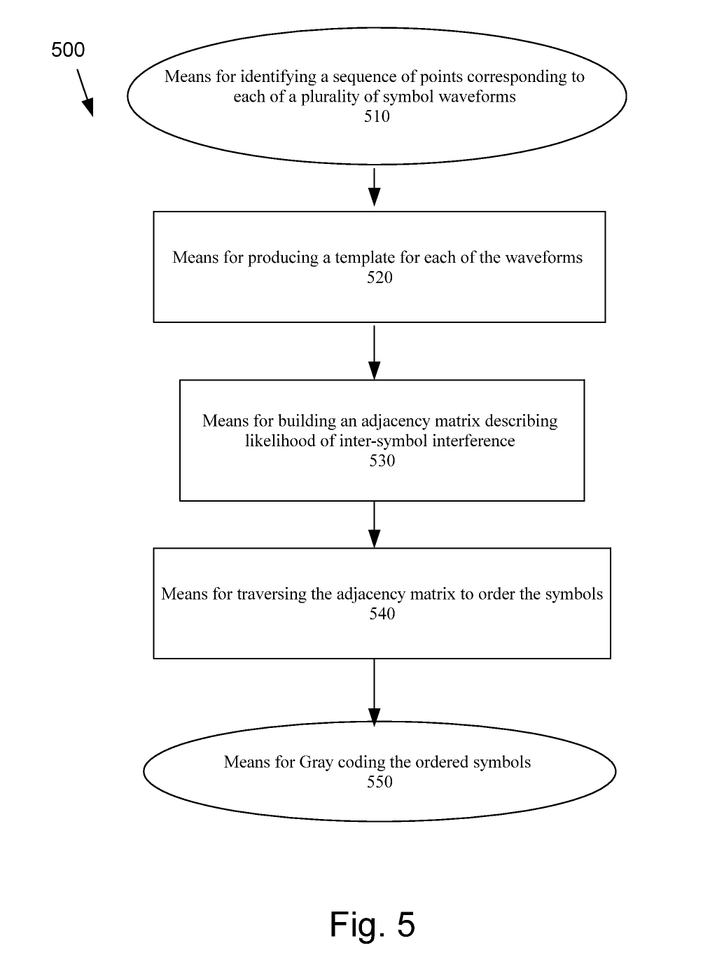

FIG. 5 is an exemplary diagram showing a flow chart of a method 500 for transmitting symbols from a symbol alphabet 505 utilizing a plurality of non-periodic symbol waveforms. The method 500 for transmitting symbols from a symbol alphabet 505 may include means for identifying a sequence of points corresponding to each of a plurality of symbol waveform templates 510, means for producing a matched filter for each symbol waveform 520, means for building an adjacency matrix describing likelihood of inter-symbol interference 530, means for analyzing the adjacency matrix to order the symbols 540 and means for Gray coding the ordered symbols 550. The means for identifying step 510 may include the sequence of points sampled from a non-periodic waveform or the like. The means for producing step 520 may include standard techniques for generating matched filters. The means for building step 530 may involve convolving all matched filters (columns) with all symbol templates (rows), subtracting the element in the long diagonal of each column from each element in the column, and taking the absolute value. The effect may be that rows with smaller non-zero values correspond to symbols that are more likely to be confused with the correct symbol. The means for analyzing step 540 may include listing the symbols in order so that the symbols most likely to be confused with each other as indicated by the adjacency matrix are next to each other in the list. The means for Gray coding step 550 may include applying a standard Gray code such that successive symbols in the list are assigned bit sequences that differ by one bit.

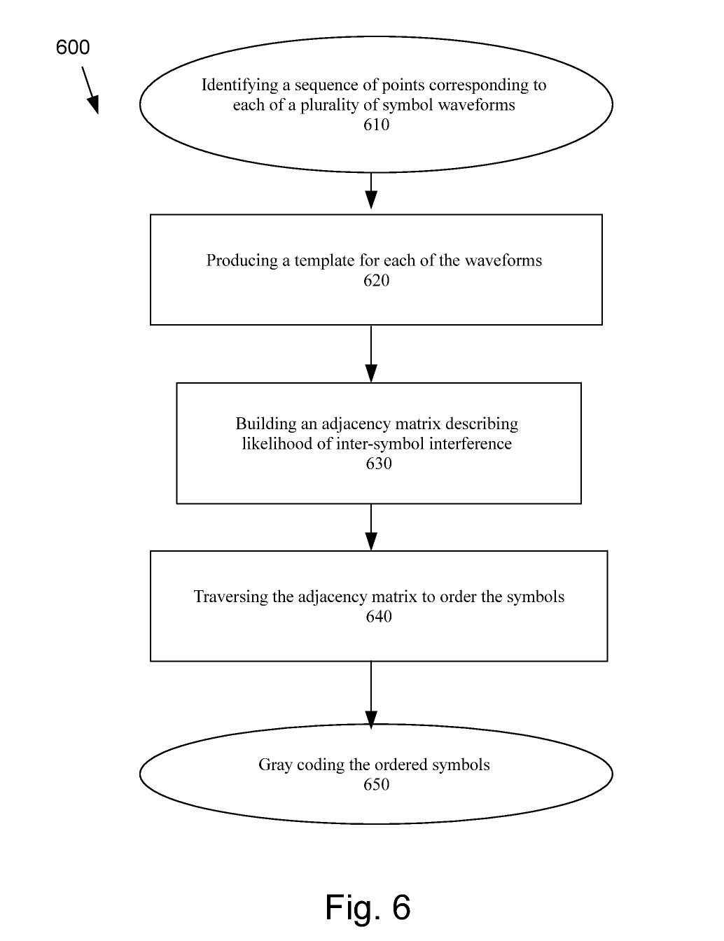

FIG. 6 is an exemplary diagram showing a flow chart of a method 600 for Gray coding a symbol alphabet transmitted utilizing a plurality of non-periodic waveforms. The method 600 may include identifying a sequence of points corresponding to each of a plurality of symbol waveforms templates 610, producing a matched filter for each of the waveform templates 620, building an adjacency matrix describing likelihood of inter-symbol interference 630, analyzing the adjacency matrix to order the symbols 640 and Gray coding the ordered symbols 650. The identifying step 610 may include the sequence of points sampled from a non-periodic waveform or the like. The producing step 620 may include standard techniques for producing matched filters. The building step 630 may involve convolving all matched filters (columns) with all symbol templates (rows), subtracting the element in the long diagonal of each column from each element in the column, and taking the absolute value. The effect may be that rows with smaller non-zero values correspond to symbols that are more likely to be confused with the correct symbol. The analyzing step 640 may include listing the symbols in order so that the symbols most likely to be confused with each other as indicated by the adjacency matrix are next to each other in the list. The Gray coding step 650 may include applying a standard Gray code such that successive symbols in the list are assigned bit sequences that differ by one bit.

A symbol alphabet is used in generally the same way whether symbols are represented by periodic or non-periodic waveforms. In either case, each symbol corresponds to a specified sequence of bits; an input bit sequence is translated into a sequence of symbols; the symbols are converted into symbol waveforms; the symbol waveforms are transmitted; the receiver attempts to determine the symbol sequence from the received (generally corrupted) symbol waveforms; and the received symbol sequence is converted into a bit sequence corresponding to the input bit sequence to within reception errors. The difference between communication systems using periodic symbol waveforms and communication systems using non-periodic symbol waveforms is that (assuming that the symbol rate is equal to the baseband bandwidth in either case) for the periodic case each symbol waveform is logically equivalent to a single complex point, whereas in the non-periodic case each symbol waveform in general corresponds to a trajectory of complex points. The difference between a single point per symbol in the periodic case and multiple points per symbol in the non-periodic case is what makes non-periodic signal modulation more noise-resistant, but also more difficult to Gray code. We now introduce terms to make the discussion of non-periodic Gray coding precise.

Let the alphabet Γ for a communication system utilizing non-periodic waveforms include the n symbols {S₀, S₁, . . . Sₙ₋₁}. Let each symbol Sₖ correspond to a non-periodic complex symbol waveform Wₖ. From each symbol waveform Wₖ a sequence of P points T_{k,p} is sampled, where the value of P is limited by hardware considerations, notably achievable sampling rate and slew rate. T_{k,p} corresponds to the symbol waveform data that will be transmitted and matched in the receiver.

Given the waveform transmission data T_{k,p} our goal is to determine which symbol waveforms are most likely to be confused with each other, in order to allow the best Gray code to be identified. This may be done by constructing and analyzing an adjacency matrix, as described below. An exemplary method for deriving symbol adjacency information for the alphabet F may be as follows. Convert T_{k,p} into a sequence of purely real values R_{k,p} by appending the real part of T_{k,p} with the imaginary part of T_{k,p}: R_{k,p}={Re(T_{k,p}), Im(T_{k,p})}. Create normalized versions of R_{k,p}, N_{k,p}=norm(R_{k,p}), such that each N_{k,p} has unit length. The N_{k,p} provides matched filters for each symbol. Create an n-by-n matrix M by taking the inner product of R_{j,p} with N_{k,p}: M_{j,k}=R_{j,p}◯N_{k,p}. Each column k of M represents the strength of the match of every symbol waveform with the matched filter for symbol k, and therefore provides information on the likelihood of inter-symbol confusion. Form a vector D of the diagonal elements of M: Dₖ=M_{k,k}. Measure how far each column element is from the diagonal element, producing an adjacency matrix: A_{j,k}=abs(M_{j,k}−Dₖ).

The adjacency matrix A_{j,k} has zeros along the long diagonal and all positive values elsewhere. Smaller non-zero values in A_{j≠k,k} imply a greater risk that the receiver will incorrectly identify a transmitted symbol j as the symbol k. The raw adjacency data necessary to Gray code the symbol set Γ is therefore present. In the present invention, this information may be used to create a symbol list in which successive symbols are most likely to be confused with each other in the receiver, and to Gray code this list so that successive symbols have bit sequences differing by only one bit. It is desired to assign similar bit sequences to symbols Sⱼ and Sₖ if A_{j,k} is relatively small. An exemplary method for doing so may be as follows. Create an empty ordered list L. Find the column k with the smallest non-zero entry in the adjacency matrix A. Add k to L. Find the row j with the smallest non-zero value in column k. Remove k from consideration in subsequent steps, for instance by deleting its data from A_{j,k}. Repeat the previous 3 steps with j replacing k, continuing until all symbol indices appear exactly once in L. Apply a standard Gray code to L such that successive symbols in L are assigned bit sequences that differ by one bit. Doing so extends the benefit of Gray coding from periodic to non-periodic signal modulation: which is that the most probable symbol confusions should result in the minimum number of bit errors.

The foregoing description and accompanying figures illustrate the principles, one or more embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments may be made by those skilled in the art without departing from the scope of the invention as defined by the following claims.

What is claimed is:

1. A Gray coding for a symbol alphabet with a plurality of symbols, comprising:
means for identifying a sequence of points corresponding to each of a plurality of non-periodic symbol waveforms utilized by the symbol alphabet;
means for producing each of the non-periodic waveforms;
means for building an adjacency matrix describing likelihood of inter-symbol interference;
means for analyzing the adjacency matrix to order the symbols; and
means for Gray coding the ordered symbols.

2. The symbol alphabet with a plurality of symbols according to claim 1, wherein the means for identifying the sequence of points is a uniformly distributed sequence of points.

3. The symbol alphabet with a plurality of symbols according to claim 1, wherein the means for identifying the sequence of points is a non-uniformly distributed sequence of points.

4. The symbol alphabet with a plurality of symbols according to claim 1, wherein the means for producing includes that symbol waveform matched filters be used to provide a measure of the likelihood of inter-symbol confusion.

5. The symbol alphabet with a plurality of symbols according to claim 1, wherein the means for producing includes a template for each of the non-periodic waveforms.

6. The symbol alphabet with a plurality of symbols according to claim 1, wherein the means for building has a plurality of zeroes along a long diagonal of the adjacency matrix and all positive values elsewhere.

7. The symbol alphabet with a plurality of symbols according to claim 1, wherein the means for Gray coding includes applying a standard Gray code to an initially empty ordered list such that successive symbols in the ordered list are assigned bit sequences that differ by one bit.

8. A method for Gray coding a symbol alphabet transmitted utilizing a plurality of non-periodic waveforms, comprising:
identifying a sequence of points corresponding to each of a plurality of non-periodic waveforms utilized with the symbol alphabet; producing a matched filter for each of the non-periodic waveforms;
building an adjacency matrix describing likelihood of inter-symbol interference;
analyzing the adjacency matrix to order the symbols; and
Gray coding the ordered symbols.

9. The symbol alphabet with a plurality of symbols according to claim 8, wherein the means for identifying the sequence of points is a uniformly distributed sequence of points.

10. The symbol alphabet with a plurality of symbols according to claim 8, wherein the means for identifying the sequence of points is a non-uniformly distributed sequence of points.

11. The method according to claim 8, wherein the producing includes that each symbol template be matched against all symbol waveforms to provide a measure of likelihood of inter-symbol confusion.

12. The method according to claim 8, wherein the building has a plurality of zeroes along a long diagonal of the adjacency matrix and all positive values elsewhere.

13. The method according to claim 8, wherein the Gray coding includes applying a standard Gray code to an initially empty ordered list such that successive symbols in the empty ordered list are assigned bit sequences that differ by one bit.
